(19) United States
(12) Patent Application Publication
(10) Pub. No.: US 2025/0253544 A1
(43) Pub. Date: Aug. 7, 2025

(54) ANTENNA ARRAY AND APPARATUS

(71) Applicant: HUAWEI TECHNOLOGIES CO., LTD., Shenzhen (CN)

(72) Inventors: Qian Zhu, Shenzhen (CN); Rui Ni, Shenzhen (CN); Ganghua Yang, Shanghai (CN); Xu Li, Shenzhen (CN)

(73) Assignee: HUAWEI TECHNOLOGIES CO., LTD., Shenzhen (CN)

(21) Appl. No.: 19/187,932

(22) Filed: Apr. 23, 2025

Related U.S. Application Data
(63) Continuation of application No. PCT/CN2023/136297, filed on Dec. 5, 2023.

(30) Foreign Application Priority Data
Dec. 6, 2022 (CN) 202211557715.8

(51) Int. Cl. H01Q 21/06; H01Q 5/392; H01Q 9/06

(52) U.S. Cl. CPC H01Q 21/062; H01Q 5/392; H01Q 9/065

(57) ABSTRACT

An antenna array and an apparatus, the antenna array include N subarrays, wherein the n^{th} subarray includes Mₙ antenna elements, N is an integer greater than 1, a value of n is an integer ranging from 1 to N, Mₙ is a positive integer, and a quantity of antenna elements in at least one of the N subarrays is greater than 1. When Mₙ is greater than 1, the Mₙ antenna elements are arranged in a first direction, a spacing between adjacent antenna elements in the Mₙ antenna elements is less than or equal to ½λ, and λ is a wavelength determined based on an operating frequency of the antenna array. The N subarrays are arranged in a second direction, and the first direction is perpendicular to the second direction; or N₁ subarrays are arranged in the second direction, and N₂ subarrays are arranged in a third direction.

### CROSS-REFERENCE TO RELATED APPLICATIONS

This application is a continuation of International Application No. PCT/CN2023/136297, filed on Dec. 5, 2023, which claims priority to Chinese Patent Application No. 202211557715.8, filed on Dec. 6, 2022. The disclosures of the aforementioned applications are hereby incorporated by reference in their entireties.

### TECHNICAL FIELD

This application relates to the field of antenna technologies, and in particular, to an antenna array and an apparatus.

### BACKGROUND

As a radio signal sending and receiving apparatus, an antenna has significant impact on wireless communication and a sensing system, especially on an antenna gain and a beam width. By increasing the antenna gain, a signal-to-noise ratio at a receiving end can be increased, improving a capacity of the wireless communication and a sensitivity of the sensing system. By decreasing the beam width, an angle resolution can be improved, improving a capacity of multi-user multiple-input multiple-output (MIMO) and a resolution of the sensing system.

Regardless of a conventional antenna array is used in MIMO or a phased array, an antenna gain and a beam width are limited by an antenna aperture area. According to a relationship between an antenna gain, a beam width, and antenna directivity, affected by costs or other factors, an antenna aperture of a base station, a terminal, or the like is limited. Therefore, a conventional antenna structure cannot further increase an antenna gain or decrease a beam width of an antenna. Consequently, directivity of the conventional antenna structure cannot be further improved.

### SUMMARY

Embodiments of this application provide an antenna array and an apparatus, to effectively implement super directivity of the antenna array.

According to a first aspect, an embodiment of this application provides an antenna array, including N subarrays. The n^{t}h subarray includes Mₙ antenna elements, N is an integer greater than 1, a value of n is an integer ranging from 1 to N, Mₙ is a positive integer, and a quantity of antenna elements in at least one of the N subarrays is greater than 1. When Mₙ is greater than 1, the Mₙ antenna elements are arranged in a first direction, a spacing between adjacent antenna elements in the Mₙ antenna elements is less than or equal to ½ λ, and λ is a wavelength determined based on an operating frequency of the antenna array. The N subarrays are arranged in a second direction, and the first direction is perpendicular to the second direction; or N₁ subarrays are arranged in the second direction, and N₂ subarrays are arranged in a third direction, where N₁ and N₂ are both positive integers, the first direction is perpendicular to the second direction, the second direction is perpendicular to the third direction, and the first direction is perpendicular to the third direction.

In this embodiment of this application, the spacing between adjacent antenna elements is less than or equal to a half wavelength, so that coupling between the antenna elements can be ensured. By properly controlling an amplitude and a phase of each antenna element, superdirectivity of the subarray can be effectively implemented. Compared with a conventional antenna in a same subarray size, an antenna according to this embodiment can implement higher directivity. In addition, the N subarrays are arranged in the second direction to form a two-dimensional antenna array; or the N₁ subarrays are arranged in the second direction and the N₂ subarrays are arranged in the third direction to form a three-dimensional antenna array. Therefore, superdirectivity of the antenna array can be further improved by using vector superposition effect of the array. N₁ and N₂ are both less than or equal to N. For example, the antenna array provided in this embodiment of this application may also be a superdirective antenna.

In an optional implementation, N=N₁*N₂.

In this embodiment of this application, when N=N₁*N₂, the antenna array may be understood as a three-dimensional cuboid array, and the cuboid antenna array is easier to deploy.

In an optional implementation, the first direction is a beam direction of the subarray.

The first direction is the beam direction of the subarray. That is, a beam of the subarray is in an endfire direction of the subarray. The antenna elements are arranged in the beam direction of the subarray, so that superdirectivity of the antenna array can be effectively ensured, and structure compactness of the antenna array can be ensured.

In an optional implementation, at least one spacing between adjacent antenna elements in the Mₙ antenna elements is less than or equal to ¼ λ.

In this embodiment of this application, at least one spacing between adjacent antenna elements is less than or equal to a quarter wavelength. Therefore, compactness of the antenna array can be effectively ensured, and an overall volume of the antenna array can be reduced, or a quantity of antenna elements can be effectively increased within a same volume, thereby further improving superdirectivity of the antenna array.

In an optional implementation, the antenna element includes a monopole antenna, a first end of the monopole antenna is a feed end, a horizontal stub is disposed at a second end of the monopole antenna, and a size of the second end in a direction perpendicular to the monopole antenna is less than or equal to the spacing between antenna elements.

In this embodiment of this application, a length of the monopole antenna can be effectively reduced by disposing the horizontal stub at the second end of the monopole antenna. The size of the second end in the direction perpendicular to the monopole antenna is less than or equal to the spacing between antenna elements, so that structure compactness of an antenna element can be ensured. This facilitates implementation and deployment of the spacing between antenna elements less than or equal to a quarter wavelength. It may be understood that the size in this embodiment of this application may also be understood as a length, a dimension, or the like.

In an optional implementation, the antenna element includes any one of the following: a differentially excited dipole antenna, a dipole antenna with a differential microstrip feed structure, and a dual-polarized antenna.

The antenna element in the antenna array provided in this embodiment of this application may not be limited to the foregoing monopole antenna, for example, may be a dipole antenna or a multi-polarized antenna.

In an optional implementation, each antenna element is connected to an amplitude adjustment unit and a phase adjustment unit, the amplitude adjustment unit is configured to adjust an amplitude of an excitation signal of the corresponding antenna element based on a weight, and the phase adjustment unit is configured to adjust a phase of an excitation signal of the corresponding antenna element based on a weight.

In this embodiment of this application, each antenna element may correspond to one amplitude adjustment unit and one phase adjustment unit, or all antenna elements correspond to one amplitude adjustment unit and one phase adjustment unit, or a plurality of antenna elements (for example, more than 1 and less than Mₙ antenna elements) correspond to one amplitude adjustment unit and one phase adjustment unit. It may be understood that, when a plurality of antenna elements correspond to one amplitude adjustment unit and one phase adjustment unit, or when all the antenna elements correspond to one amplitude adjustment unit and one phase adjustment unit, although the antenna elements correspond to the same amplitude adjustment unit and the same phase adjustment unit, the amplitude adjustment unit may still adjust an amplitude of each antenna element, and the phase adjustment unit may still adjust a phase of each antenna element. This effectively ensures that each antenna element can correspond to excitation of one antenna port.

Optionally, both the amplitude adjustment unit and the phase adjustment unit may be hardware devices, or the amplitude adjustment unit and the phase adjustment unit may be controlled by a baseband processing circuit. It may be understood that the units described in this embodiment of this application may be implemented in a form of hardware, or may be implemented in a form of a software functional module. Division into the modules is an example and may be understood as logical function division. In actual implementation, there may be another division manner.

In an optional implementation, the antenna array further includes a weight generation unit, and the weight generation unit is configured to generate the weight.

In an optional implementation, the weight includes a superdirective weight, and the superdirective weight is used by the antenna array to generate a superdirective beam.

In an optional implementation, at least two of the Mₙ antenna elements correspond to different impedance matching circuits.

For example, when all the antenna elements use a same impedance matching circuit, an edge antenna element and a middle antenna element cannot match optimal impedance simultaneously, and an overall bandwidth of the subarray or the antenna array is reduced. However, in this embodiment of this application, at least two of the Mₙ antenna elements correspond to different impedance matching circuits. Therefore, impact of coupling effect of a surrounding antenna can be effectively reduced, and the overall bandwidth of the subarray or the antenna array can be ensured.

In an optional implementation, the amplitude adjustment unit includes an unequal power divider, and each of the Mₙ antenna elements corresponds to one unequal power divider, or a plurality of antenna elements in the Mₙ antenna elements correspond to one unequal power divider.

In an optional implementation, beamforming used between subarrays includes at least one of the following: digital beamforming and analog beamforming.

According to a second aspect, an embodiment of this application provides an active antenna unit, including the antenna array according to any one of the first aspect or the possible implementations.

According to a third aspect, an embodiment of this application provides a communication apparatus, including the antenna array according to any one of the first aspect or the possible implementations and a baseband processing circuit.

### BRIEF DESCRIPTION OF DRAWINGS

FIG. 1 is a diagram of a structure of an antenna array according to an embodiment of this application;

FIG. 2 is a diagram of a structure of an antenna array according to an embodiment of this application;

FIG. 3a is a diagram of an antenna array according to an embodiment of this application;

FIG. 3b is a diagram of a structure of an antenna element in FIG. 3a;

FIG. 4a is a diagram of controlling a subarray beam by a weight generation unit according to an embodiment of this application;

FIG. 4b is a diagram of a structure of a communication apparatus according to an embodiment of this application;

FIG. 5 is a diagram of a structure of a monopole-based antenna element according to an embodiment of this application;

FIG. 6 is a diagram of a structure of a dipole antenna element based on coaxial differential feeding according to an embodiment of this application;

FIG. 7 is a diagram of a structure of a subarray according to an embodiment of this application;

FIG. 8a is a diagram of a structure of a subarray including four antenna elements;

FIG. 8b is a diagram of a structure of a uniform linear array including four subarrays;

FIG. 9a is a diagram of simulation results according to an embodiment of this application;

FIG. 9b is a diagram of simulation results according to an embodiment of this application;

FIG. 10a is a diagram of beamforming according to an embodiment of this application;

FIG. 10b is a diagram of comparison of beams in an endfire direction according to an embodiment of this application;

FIG. 10c is a diagram of comparison of beams in a broadside direction according to an embodiment of this application;

FIG. 11 is a diagram of a structure of a subarray based on a dual-polarized antenna according to an embodiment of this application;

FIG. 12 is a diagram of a structure of a subarray based on different impedance matching circuits according to an embodiment of this application;

FIG. 13a is a diagram of a structure of a subarray based on a series feed network according to an embodiment of this application;

FIG. 13b is a diagram of a structure of a subarray based on a series feed network according to an embodiment of this application;

FIG. 13c is a diagram of a fixed amplitude and phase adjustment structure based on a microstrip structure according to an embodiment of this application; and

FIG. 14 is a diagram of a structure of a subarray based on a parallel feed network according to an embodiment of this application.

### DESCRIPTION OF EMBODIMENTS

To make the objectives, technical solutions, and advantages of this application clearer, this application is further described with reference to the accompanying drawings.

“Embodiments” in this specification mean that specific features, structures, or characteristics described in combination with the embodiments may be included in at least one embodiment of this application. The phrase appearing in various locations in the specification may not necessarily refer to a same embodiment, and is not an independent or optional embodiment exclusive from another embodiment. It may be understood explicitly and implicitly by a person skilled in the art that embodiments described in this specification may be combined with other embodiments.

In this application, “at least one (item)” means one or more, “a plurality of” means two or more, “at least two (items)” means two or three or more, and “and/or” is used to describe an association relationship between associated objects, which indicates that three relationships may exist. For example, “A and/or B” may indicate: only A exists, only B exists, and both A and B exist. A and B may be singular or plural. “Or” indicates that two relationships may exist, for example, only A exists and only B exists. When A and B are not mutually exclusive, it may indicate that three relationships exist, for example, only A exists, only B exists, and both A and B exist. The character “/” generally indicates an “or” relationship between the associated objects. “At least one of the following items (pieces)” or a similar expression thereof means any combination of these items. For example, at least one item (piece) of a, b, or c may represent: a, b, c, “a and b”, “a and c”, “b and c”, or “a, b, and c”.

Currently, there is an antenna array in which a spacing between antenna elements is about a half wavelength or greater than a half wavelength. Due to a limitation of an effective antenna aperture, maximum directivity is D₀=, where 4πA_{eff}/λ², is an equivalent antenna aperture, and λ is a wavelength of an electromagnetic wave. The wavelength may be understood as the wavelength of the electromagnetic wave after medium effect is considered. A conventional antenna array is limited by an antenna aperture area, and maximum achievable directivity is limited.

In view of this, embodiments of this application provide an antenna array, to effectively implement beam effect of superdirectivity and a high resolution (for example, implement a narrow beam width, and the narrow bandwidth enables a high angle resolution). When the antenna array is in a three-dimensional structure, the antenna array provided in embodiments of this application may also be referred to as a bandwidth three-dimensional antenna array, an antenna array in a three-dimensional structure, or the like. A specific name of the antenna array is not limited in embodiments of this application.

Generally, directivity of the antenna array is inversely proportional to a beam width. Higher directivity indicates a narrower beam width. For example, directivity of the antenna array may be determined by an antenna aperture. Because an antenna radiates electromagnetic waves in all directions, the antenna may have directivity at each angle. Directivity described in embodiments of this application may be understood as maximum directivity in directivity at all angles.

The following describes terms in embodiments of this application.

Antenna element: a basic element that forms an antenna array. Each antenna element has one antenna port, and may be separately provided with an excitation signal.

Subarray: A plurality of antenna elements form one subarray.

Array: A plurality of subarrays form one antenna array.

The antenna array provided in embodiments of this application may be described as follows:

including N subarrays, where the n^{t}h subarray includes Mₙ antenna elements, N is an integer greater than 1, a value of n is an integer ranging from 1 to N, Mₙ is a positive integer, and a quantity of antenna elements in at least one of the N subarrays is greater than 1. For example, the 1^{st} subarray may include M₁ antenna elements, the 2^{nd} subarray may include M₂ antenna elements, . . . , and the N^{t}h subarray may include M_{N} antenna elements. At least one of M₁, M₂, . . . , and M_{N} is greater than 1. For example, M₁, M₂, . . . , and M_{N} may all be integers greater than 1. Optionally, a quantity of antenna elements in each subarray may be the same. Therefore, an antenna shape is more regular, to facilitate deployment of the antenna array. In addition, a regular antenna can effectively reduce an amount of calculation for weight generation during beamforming, to reduce complexity. Optionally, at least two of the N subarrays may have different quantities of antenna elements. For example, each subarray includes a different quantity of antenna elements. Examples are not enumerated herein.

When Mₙ is greater than 1, the Mₙ antenna elements are arranged in a first direction, a spacing between adjacent antenna elements in the Mₙ antenna elements is less than or equal to ½ λ, and λ is a wavelength determined based on an operating frequency of the antenna array. In other words, Mₙ antenna elements included in each of the N subarrays are arranged in the first direction. For example, M₁, M₂, . . . , and M_{N} may all be integers greater than 1, the M₁ antenna elements included in the 1^{st} subarray are arranged in the first direction, the M₂ antenna elements included in the 2^{nd} subarray are arranged in the first direction, . . . , and the M_{N} antenna elements included in the N^{t}h subarray are arranged in the first direction. For example, that the spacing between adjacent antenna elements is less than or equal to ½ λ may be understood as: A size of the antenna element in a direction in which a spacing is less than or equal to ½ λ is less than or equal to ½ λ.

Optionally, the spacing between adjacent antenna elements in the Mₙ antenna elements is less than or equal to ¼ λ. In this case, for specific descriptions of the antenna element, refer to the following description of a monopole antenna, as described in Example 1 below.

For example, the spacing between adjacent antenna elements may be equal to ½ λ, or slightly less than ½ λ, or less than ½ λ and greater than ¼ λ, or equal to ¼ λ, or less than ¼ λ or even smaller. Examples are not enumerated. It may be understood that the spacing between antenna elements described in embodiments of this application is less than or equal to a half wavelength, or less than or equal to a quarter wavelength. During specific implementation, the spacing between antenna elements is further related to conductivity, a dielectric constant, a structure, and the like of a material. Therefore, there may be a deviation ε in the spacing between antenna elements. A specific value of E is not enumerated in embodiments of this application. Due to the deviation, that the spacing between antenna elements is less than or equal to a half wavelength may also be described as: The spacing between antenna elements is approximately less than or equal to a half wavelength. That the spacing between antenna elements is less than or equal to a quarter wavelength may also be described as: The spacing between antenna elements is approximately less than or equal to a quarter wavelength. By analogy, all descriptions related to a size in embodiments of this application may be described similarly.

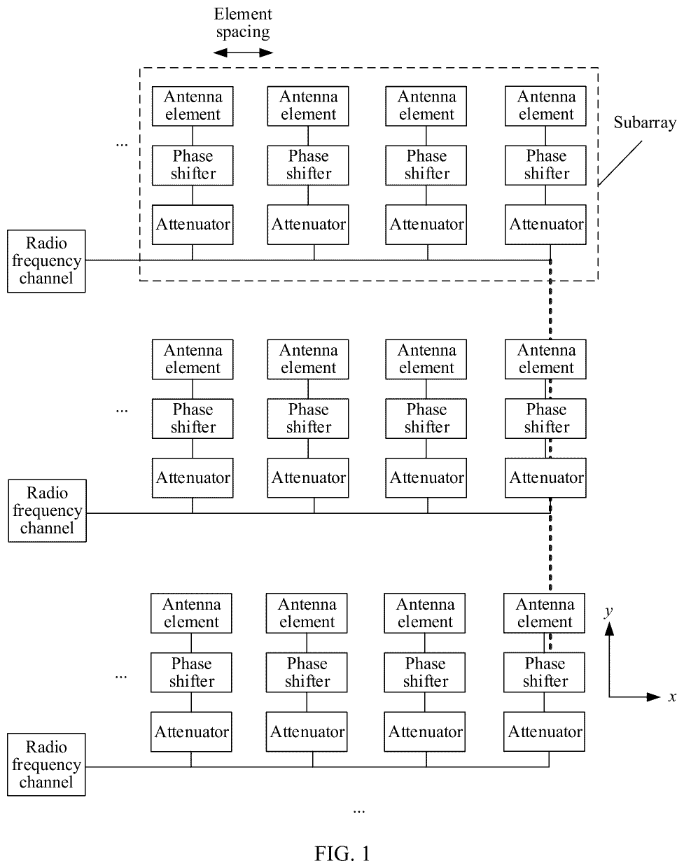

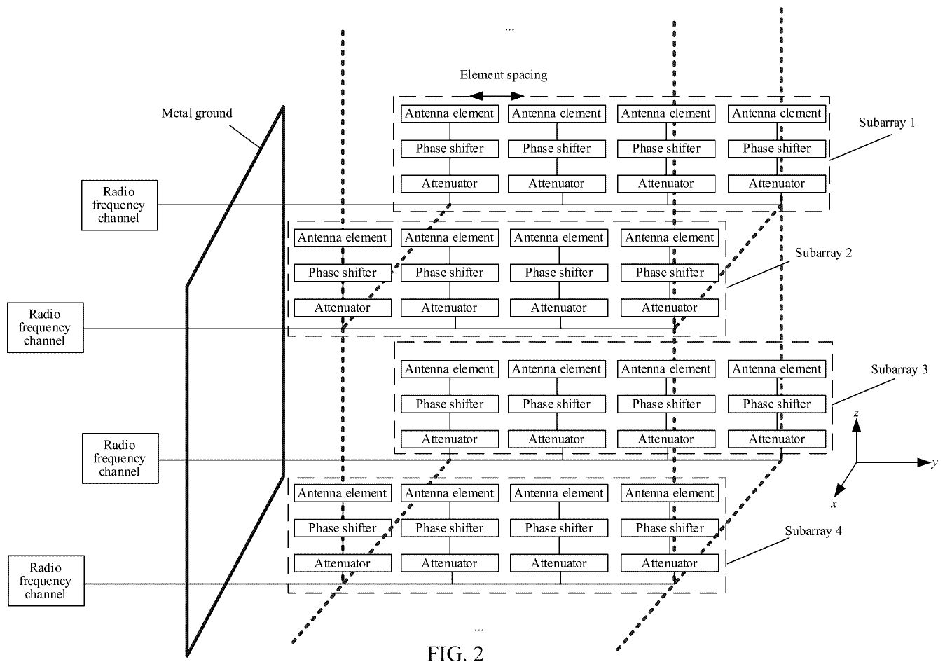

A plurality of antenna elements are arranged in the first direction to form a subarray. Optionally, a metal reflector plate (a metal ground shown in FIG. 1 and FIG. 2) may be configured for each subarray to isolate a radio frequency front-end circuit from an antenna, so that impact of the radio frequency front-end circuit on performance of the antenna can be effectively reduced. The metal reflector plate is perpendicular to the subarray arrangement direction, and a size of the metal reflector plate is less than or equal to a subarray spacing. A distance between the metal reflector plate and a nearest antenna element is less than or equal to one wavelength.

In an example, the N subarrays may be arranged in a second direction, and the first direction is perpendicular to the second direction. FIG. 1 is a diagram of a structure of an antenna array according to an embodiment of this application. As shown in FIG. 1, the first direction may include an x-axis direction, and the second direction may include a y-axis direction. Certainly, the first direction and the second direction shown in FIG. 1 are merely examples. For example, the first direction may include the y-axis direction, and the second direction may include the x-axis direction. The antenna array shown in FIG. 1 may also be referred to as an antenna array in a two-dimensional structure or a two-dimensional array.

It may be understood that, a quantity of antenna elements (for example, four antenna elements shown in FIG. 1) included in one subarray shown in FIG. 1 is merely an example. In actual application, one subarray may alternatively have more antenna elements or fewer antenna elements than the quantity of antenna elements shown in FIG. 1. A quantity of subarrays (for example, three subarrays shown in FIG. 1) included in one antenna array shown in FIG. 1 is merely an example. In actual application, one antenna array may alternatively have more subarrays or fewer subarrays than the quantity of subarrays shown in FIG. 1.

In another example, N₁ subarrays are arranged in the second direction, and N₂ subarrays are arranged in a third direction. N₁ and N₂ are both positive integers, the first direction is perpendicular to the second direction, the second direction is perpendicular to the third direction, and the first direction is perpendicular to the third direction. Therefore, the antenna array may include a cuboid array, a cylindrical array, a sphere array, or the like.

FIG. 2 is a diagram of a structure of an antenna array according to an embodiment of this application. As shown in FIG. 2, the first direction may include a y-axis direction, the second direction may include an x-axis direction, and the third direction may include a z-axis direction. Alternatively, the first direction may include the y-axis direction, the second direction may include the z-axis direction, and the third direction may include the x-axis direction. It may be understood that the first direction, the second direction, and the third direction shown in FIG. 2 are merely examples, and should not be construed as a limitation on this embodiment of this application. It may be understood that two subarrays are arranged in the x-axis direction shown in FIG. 2, for example, a subarray 1 and a subarray 2, or a subarray 3 and a subarray 4. It may be understood that two subarrays are arranged in the z-axis direction shown in FIG. 2, for example, the subarray 1 and the subarray 3, or the subarray 2 and the subarray 4. It may be understood that, for ease of describing a relative location relationship between subarrays, FIG. 2 shows some dashed lines. For example, two subarrays located on a same dashed line may be understood as: The two subarrays are on a line parallel to a corresponding coordinate axis.

It may be understood that the antenna array shown in FIG. 2 is shown as an example of a cuboid array. In this case, N=N₁*N₂. The cuboid array is easier to deploy. Certainly, the cuboid array shown in this embodiment of this application is merely an example. For example, the antenna array provided in this embodiment of this application includes but is not limited to a cuboid array, a cube array, a cylinder array, or a sphere array. For example, the cylinder array and the sphere array can achieve a more uniform omnidirectional direction.

It may be understood that, a quantity of antenna elements (for example, four antenna elements shown in FIG. 2) included in one subarray shown in FIG. 2 is merely an example. In actual application, one subarray may alternatively have more antenna elements or fewer antenna elements than the quantity of antenna elements shown in FIG. 2. A quantity of subarrays (for example, four subarrays shown in FIG. 2) included in one antenna array shown in FIG. 2 is merely an example. In actual application, one antenna array may alternatively have more subarrays or fewer subarrays than the quantity of subarrays shown in FIG. 2. A quantity of subarrays in the x-axis direction and a quantity of subarrays in the z-axis direction shown in FIG. 2 are merely examples, and should not be construed as a limitation on this embodiment of this application.

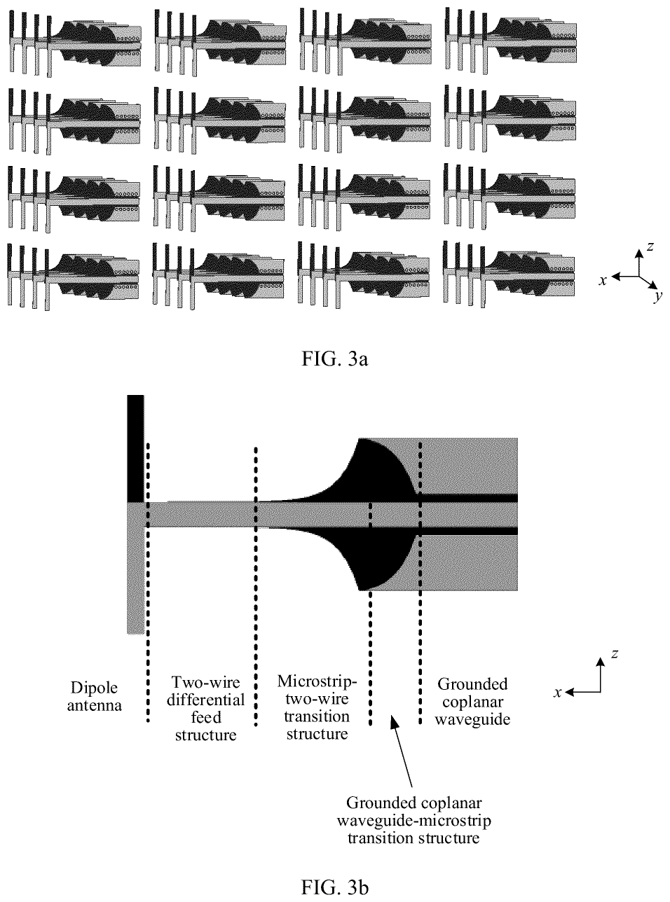

FIG. 3a is a diagram of an antenna array according to an embodiment of this application. As shown in FIG. 3a, four subarrays are arranged in an x-axis direction, four subarrays are arranged in a z-axis direction, and antenna elements in each subarray are arranged in a y-axis direction. For example, for an antenna element in the antenna array shown in FIG. 3a, refer to FIG. 3b. FIG. 3b shows an example in which an antenna element includes a dipole antenna. As shown in FIG. 3b, each antenna element includes a dipole antenna serving as a radiation part and a transmission part. The transmission part includes a two-wire differential feed structure, a microstrip-two-wire transition structure, and a microstrip structure. The microstrip structure is an unbalanced feed structure, and includes a signal line and a ground. The two-wire differential feed structure is two transmission lines that are parallel to each other, and electromagnetic waves on the two lines are differential signals with a same amplitude and opposite phases. The microstrip-two-wire transition structure provides transition from the microstrip structure to the two-wire differential feed structure. For example, the ground in the microstrip structure is gradually changed to a two-wire structure through a tapered structure, and a width gradually becomes similar to that of the signal line. An edge of the tapered structure may be straight, or may be an arc, or may be in a shape of another curve. One end of the microstrip feed structure is connected to the tapered structure, and the other end is connected to an antenna terminal, or may be connected to a coplanar waveguide through a coplanar waveguide-microstrip transition structure, or may be connected to a grounded coplanar waveguide through a grounded coplanar waveguide-microstrip transition structure, to facilitate the antenna terminal or another feed form. A ground of the coplanar waveguide or the grounded coplanar waveguide and a transmission line in a same plane may also use the foregoing tapered structure. For ease of distinguishing parts of the dipole antenna, some dashed lines are added in FIG. 3b.

It may be understood that the antenna array shown in FIG. 3a and the antenna element shown in FIG. 3b are merely examples, and should not be construed as limitations on this embodiment of this application.

In this embodiment of this application, the spacing between adjacent antenna elements is less than or equal to a half wavelength, so that strong coupling between the antenna elements can be ensured, and superdirectivity of the antenna array can be effectively implemented. In addition, the N subarrays are arranged in the second direction to form a two-dimensional antenna array; or the N₁ subarrays are arranged in the second direction and the N₂ subarrays are arranged in the third direction to form a three-dimensional antenna array. Therefore, directivity of superdirectivity can be further improved.

The antenna array described in this embodiment of this application may further meet the following conditions (or features):

For example, each of the Mₙ antenna elements may have one antenna excitation port. Optionally, a plurality of antenna elements in the Mₙ antenna elements may further correspond to a same antenna excitation port, so that an area of the antenna array can be effectively reduced. Relationships between an antenna excitation port and an antenna element are not enumerated in this embodiment of this application.

For example, the first direction may be a beam direction of the subarray, that is, an endfire direction of the subarray. In this embodiment of this application, antenna elements are arranged in the beam direction of the subarray, so that superdirectivity of the antenna array can be effectively ensured. For example, superdirectivity in the first direction is implemented.

For example, an inter-subarray spacing may be greater than ½ λ. If the inter-subarray spacing is greater than a half wavelength, coupling between subarrays can be reduced, and conventional beamforming and MIMO diversity and multiplexing are supported.

For example, the inter-subarray spacing may be less than or equal to ½ λ. In an example, a spacing between the N₁ subarrays arranged in the second direction may be less than or equal to ½ λ. Therefore, the antenna array can effectively implement superdirectivity in the first direction or the second direction. In another example, a spacing between the N₂ subarrays arranged in the third direction may be less than or equal to ½ λ. Therefore, the antenna array can effectively implement superdirectivity in the first direction or the third direction. In still another example, a spacing between the N₁ subarrays arranged in the second direction may be less than or equal to ½ λ, and a spacing between the N₂ subarrays arranged in the third direction may be less than or equal to ½ λ. The inter-subarray spacing is less than a half wavelength, and inter-subarray coupling may be used to implement superdirectivity in another direction, for example, implement superdirectivity in the second direction, thereby improving directivity of the antenna array.

For example, digital beamforming may be used between the subarrays. For example, each subarray may be connected to one radio frequency channel. Alternatively, analog beamforming may be used between the subarrays. For example, all the subarrays are connected to one radio frequency channel. Alternatively, a hybrid beamforming structure is used between the subarrays. For example, there is a mapping relationship between a subarray and a radio frequency channel. For example, a plurality of subarrays may correspond to one radio frequency channel. It may be understood that FIG. 1 and FIG. 2 are shown by using digital beamforming as an example, and should not be construed as a limitation on this embodiment of this application. For ease of description, the following describes the antenna array provided in this embodiment of this application by using an example in which a structure of digital beamforming is used between the subarrays.

It may be understood that the antenna array above is described by using an example in which N is greater than 1. In some cases, N may be equal to 1. In this case, one antenna array may include one subarray, and the subarray may include a plurality of antenna elements. The plurality of antenna elements are arranged in the first direction, and a spacing between the plurality of antenna elements is less than or equal to ½ λ.

In this embodiment of this application, the spacing between adjacent antenna elements is less than or equal to a half wavelength, so that coupling between the antenna elements can be ensured. By properly controlling an amplitude and a phase of each antenna element, superdirectivity of the antenna array can be effectively implemented. Compared with a conventional antenna in a same subarray size, an antenna according to this embodiment can implement higher directivity. In addition, the N subarrays are arranged in the second direction to form a two-dimensional antenna array; or the N₁ subarrays are arranged in the second direction and the N₂ subarrays are arranged in the third direction to form a three-dimensional antenna array. Therefore, directivity of superdirectivity can be further improved by using vector superposition effect of the array.

Compared with a conventional antenna array, in the two-dimensional antenna array provided in this embodiment of this application, the spacing between antenna elements is less than or equal to a half wavelength, to effectively implement superdirectivity in the first direction. Compared with a conventional antenna array, the three-dimensional antenna array provided in this embodiment of this application can implement amplitude and phase adjustment in three dimensions, to improve a dimension and freedom for adjusting the antenna array, and effectively improve superdirectivity of the antenna array.

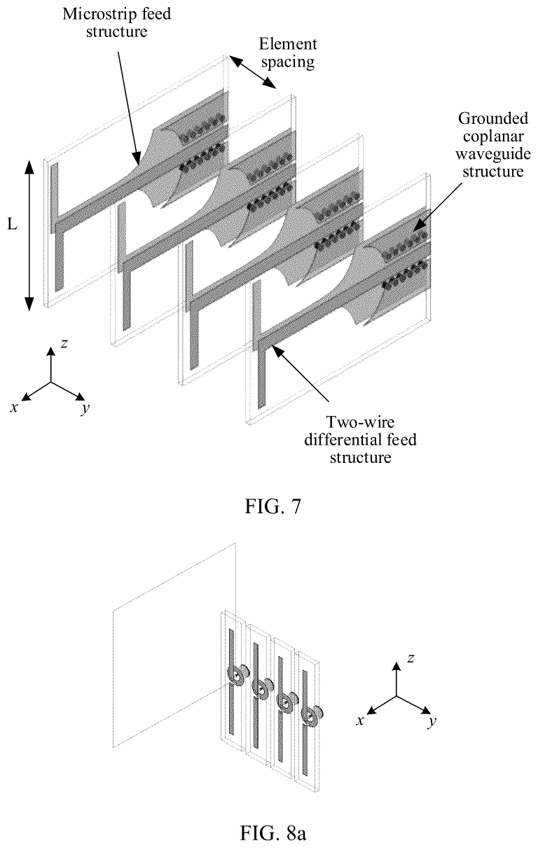

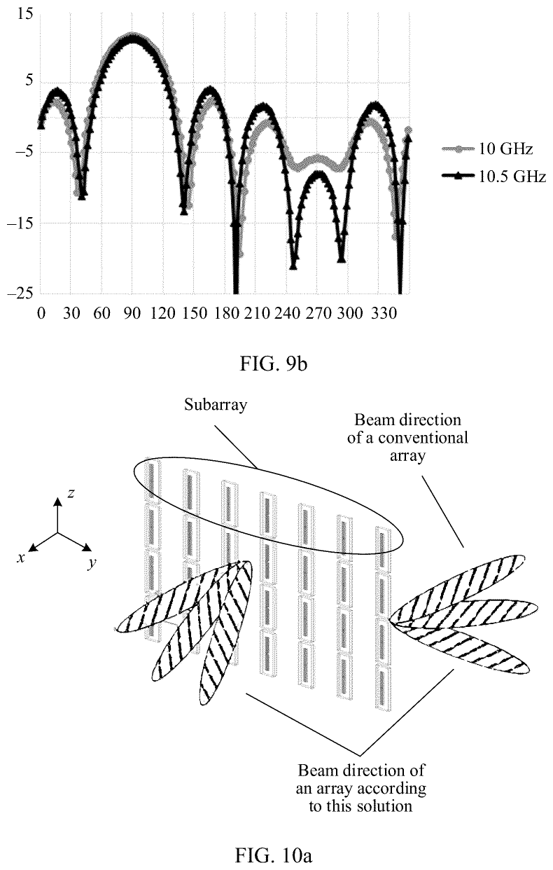

Currently, there is a dipole-based superdirective antenna, and an antenna element is a dipole antenna. For example, four antenna elements are arranged along the y-axis to form a linear array. Currently, there is still a superdirective antenna based on digital beam combining. This antenna also forms a linear array by using a plurality of antenna elements, and uses fully digital beamforming. Digital domain weighting needs to be performed in a baseband processing circuit, and radio frequency channels of a quantity the same as a quantity of antenna elements are required. This causes hardware costs and radio frequency power consumption of a large quantity of radio frequency channels. The foregoing two types of superdirective antennas may be equivalent to the subarray in the antenna array provided in this embodiment of this application. Therefore, directivity of both the foregoing two types of superdirective antennas is limited. In addition, because a beam of the superdirective antenna is in an endfire direction, more antenna elements need to be used to implement higher directivity. Consequently, a size of an antenna in the beam direction is excessively large, and this is not conducive to deployment. In addition, as a quantity of antenna elements increases, to implement superdirectivity, an excitation coefficient of each antenna in an array, especially amplitude adjustment, becomes more complex. However, in the antenna array provided in this embodiment of this application, a plurality of antenna elements form one subarray, and a plurality of subarrays form one antenna array. This structure can effectively enhance superdirectivity of the antenna array, and enhance beamforming effect of the antenna array. For example, in the antenna array provided in this embodiment of this application, in addition to digital beamforming, antenna elements in the subarray that implements superdirectivity may further use analog beamforming. Using analog beamforming can effectively reduce hardware costs and power consumption losses caused by a plurality of radio frequency channels (compared with the foregoing superdirective antenna based on digital beam combining). In addition, the foregoing dipole antenna does not consider specific implementations of antenna feeding, grounding, and amplitude adjustment and phase adjustment. Neither the dipole antenna nor the antenna based on digital beam combining considers broadband communication. However, in some embodiments of this application, the antenna array may use a coaxial differential feed structure or a differential microstrip feed structure to excite the dipole antenna (as shown in FIG. 3b and FIG. 7), to implement a broadband response (as shown in FIG. 9b, bandwidth responses in a plurality of frequencies are considered), and impact of a metal ground on performance of the subarray is considered.

Currently, there is still a three-dimensional antenna structure based on a multilayer substrate. In this antenna structure, to reduce an area of a two-dimensional antenna and implement a compact antenna structure, the two-dimensional antenna is converted into a three-dimensional antenna. For example, a part of the original two-dimensional antenna is located at the 1s′ layer of the substrate, a part of the original two-dimensional antenna is located at the 2^{nd} layer of the substrate, and so on. The 1^{st} layer and the 2^{nd} layer overlap and are connected via a path. An overall area of the antenna is reduced by using the multi-layer structure. However, such an antenna array implements antenna miniaturization based on the multi-layer structure. That is, the foregoing antenna array is mainly used for antenna miniaturization, and the multi-layer structure of the foregoing antenna array is excited by one antenna port. However, in this embodiment of this application, the multi-layer structure of the antenna array may include a plurality of antenna ports, and excitation is performed by using a proper weight, to implement superdirectivity.

The antenna array described in this embodiment of this application may further meet the following conditions:

For example, each antenna element is connected to an amplitude adjustment unit and a phase adjustment unit, the amplitude adjustment unit is configured to adjust an amplitude of an excitation signal of the corresponding antenna element based on a weight, and the phase adjustment unit is configured to adjust a phase of an excitation signal of the corresponding antenna element based on a weight.

In this embodiment of this application, each antenna element may correspond to one amplitude adjustment unit and one phase adjustment unit, or all antenna elements correspond to one amplitude adjustment unit and one phase adjustment unit, or a plurality of antenna elements (for example, more than 1 and less than Mₙ) correspond to one amplitude adjustment unit and one phase adjustment unit. Optionally, both the amplitude adjustment unit and the phase adjustment unit may be hardware device, or the amplitude adjustment unit and the phase adjustment unit may be controlled by a baseband processing circuit.

It may be understood that the units (for example, the amplitude adjustment unit, the phase adjustment unit, and a weight generation unit described below) described in this embodiment of this application may be implemented in a form of hardware, or may be implemented in a form of a software functional module. Division into the modules is an example and may be understood as logical function division. In actual implementation, there may be another division manner. It may be understood that, the antenna element may be directly or indirectly connected to the amplitude adjustment unit and the phase adjustment unit. A connection between an antenna element and a phase shifter shown in FIG. 1 and FIG. 2 may be understood as a direct connection, and a connection between an antenna element and an attenuator may be understood as an indirect connection. Certainly, the indirect connection shown in this embodiment of this application may alternatively be in another manner, which is not enumerated in this embodiment of this application.

As shown in FIG. 1 and FIG. 2, each antenna element is connected to an attenuator for amplitude adjustment, and is connected to a phase shifter for phase adjustment, so that each element has amplitude and phase adjustment capabilities. It may be understood that FIG. 1 and FIG. 2 both show an example in which each antenna element corresponds to one amplitude adjustment unit and one phase adjustment unit. The phase shifter in FIG. 1 and FIG. 2 may be understood as the phase adjustment unit, and the attenuator shown in FIG. 1 and FIG. 2 may be understood as the amplitude adjustment unit. The phase shifters and the attenuators shown in FIG. 1 and FIG. 2 are merely examples, and should not be construed as a limitation on this embodiment of this application. Certainly, the attenuator for adjusting an amplitude of an excitation signal and the phase shifter for adjusting a phase of an excitation signal shown in FIG. 1 and FIG. 2 are merely examples. In an actual application, the attenuator and the phase shifter may be implemented by other devices. For example, a gain amplifier may be configured to adjust an amplitude, and an unequal power divider described below may also be configured to adjust an amplitude. The antenna elements in the subarrays shown in FIG. 1 and FIG. 2 may be connected through a parallel or serial feed network.

In an optional implementation, the weight may be determined by a weight generation unit. That is, the weight generation unit may be configured to generate the weight. For example, the weight may include a superdirective weight, and the superdirective weight is used by the antenna array to generate a superdirective beam. The superdirective antenna may be understood as an antenna array with directivity that is clearly higher than that of an antenna array in a same size with uniform amplitude and phase excitation. For example, the superdirective antenna may be understood as: A difference between directivity of the superdirective antenna and directivity of the antenna array in a same size with uniform amplitude and phase excitation is greater than a threshold. A specific value of the threshold is not limited in this embodiment of this application. For example, the threshold may be greater than 0. Correspondingly, the superdirective weight may be understood as an excitation coefficient for implementing the superdirective antenna.

In an optional implementation, the N subarrays may correspond to at least one angle estimation unit, and the angle estimation unit may be configured to receive a beam or send a beam.

For example, any antenna element in each of the N subarrays may be used as an angle estimation unit, and the angle estimation unit may be connected to a transceiver link and the weight generation unit. For example, a step or function performed by the angle estimation unit may also be implemented by the baseband processing circuit. For example, the baseband processing circuit may estimate an angle of arrival (AoA) and/or an angle of departure (AoD) of a beam based on a beam received by the angle estimation unit or a beam sent by the angle estimation unit, and input the AoA and/or the AoD to the weight generation unit. In an example, the angle estimation unit may estimate the AoA or the AoD based on a received sounding signal, for example, estimate the AoA based on the received sounding signal, and determine the AoD based on channel reciprocity after estimating the AoA based on the received sounding signal. In another example, the angle estimation unit may estimate the AoD based on the sent sounding signal, and determine the AoA based on channel reciprocity. In another example, the angle estimation unit may estimate the AoA and/or the AoD based on the sent sounding signal.

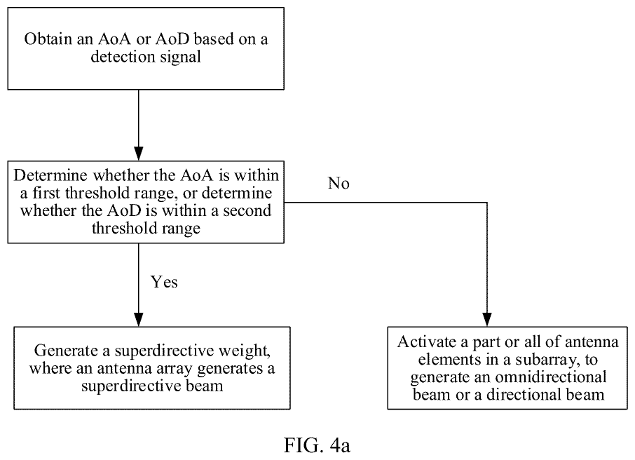

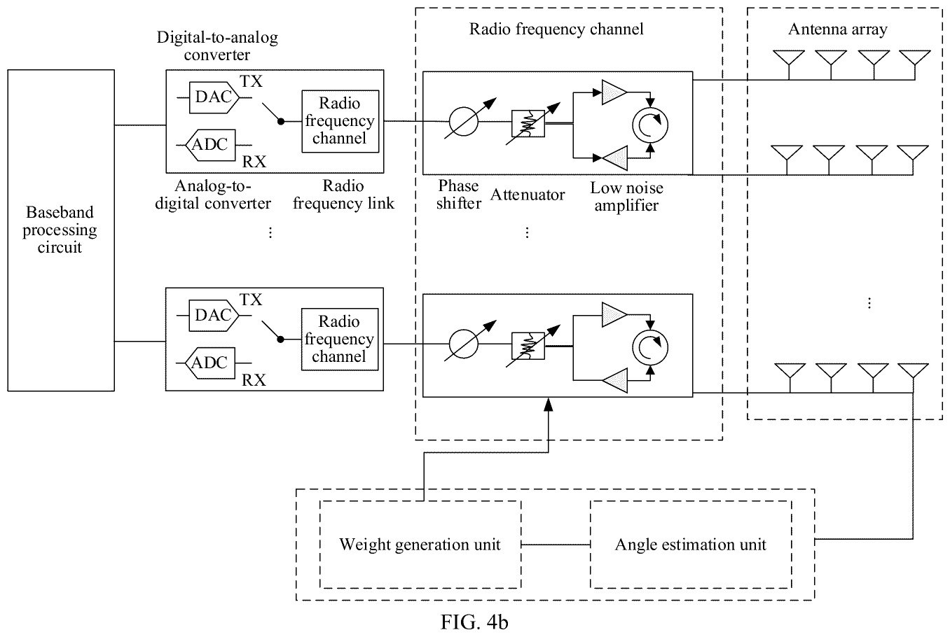

For example, the baseband processing circuit may configure amplitudes and phases of all antenna elements based on an output result of the weight generation unit. For example, the baseband processing circuit may control the amplitude adjustment unit and the phase adjustment unit based on the output result of the weight generation unit. Optionally, as shown in FIG. 4a, after the angle estimation unit obtains the AoA based on the received sounding signal, the baseband processing circuit may determine whether the AoA is within a first threshold range. If the AoA is within the first threshold range, the weight generation unit may generate a superdirective weight, and excite an antenna element in the subarray, so that the subarray generates a superdirective beam. If the AoA is not within the first threshold range, the weight generation unit may generate another corresponding weight, so that a part or all of the antenna elements in the subarray are activated, and a weight of an omnidirectional or directional beam is generated. Optionally, as shown in FIG. 4a, after the angle estimation unit obtains the AoD based on the sent sounding signal, the baseband processing circuit may determine whether the AoD is within a second threshold range. If the AoD is within the second threshold range, the weight generation unit may generate a superdirective weight, and excite an antenna element in the subarray, so that the subarray generates a superdirective beam. If the AoD is not within the second threshold range, the weight generation unit may generate another corresponding weight, so that a part or all of the antenna elements in the subarray are activated, and a weight of an omnidirectional or directional beam is generated. For example, if a direction of the AoA or the AoD is in a direction of a broadside beam of the subarray, the weight generation unit may generate a corresponding weight configuration (for example, the antenna elements are of an equal amplitude and a same phase), so that the subarray generates the broadside beam. For another example, the weight generation unit may activate a weight of only one antenna element to generate an omnidirectional beam.

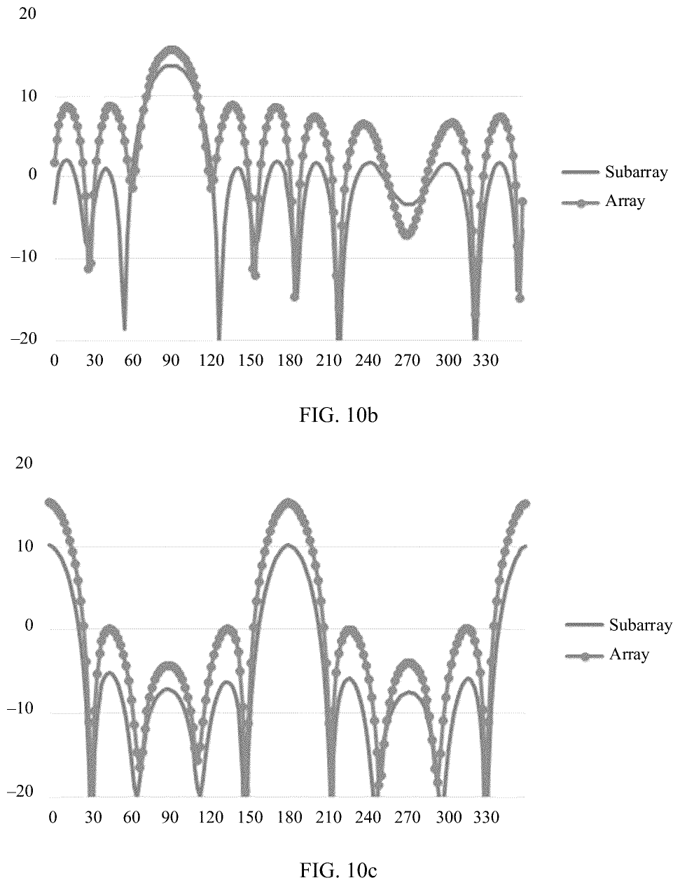

For example, beam adjustment between antenna elements in a subarray may further cooperate with beam adjustment between subarrays, to further improve a beamforming capability of the entire array. Related descriptions of improving large-angle scanning are described below, and related descriptions in FIG. 10a are also described below. For example, a beam direction of the subarray may be set to point along a y-axis (endfire). Therefore, a beam direction of the antenna array may scan within a hemisphere including the y-axis. As shown in FIG. 10a, subarrays are deployed along a z-axis, and a beam may scan within a y-z plane. The beam direction of the subarray may also be set to point along an x-axis (broadside). Therefore, the beam direction of the antenna array may scan within a hemisphere including the x-axis.

FIG. 4b is a diagram of a structure of a communication apparatus according to an embodiment of this application. As shown in FIG. 4b, the communication apparatus includes at least one of the following: a baseband processing circuit, a digital-to-analog converter (DAC), an analog-to-digital converter (ADC), a radio frequency link, a phase shifter, an attenuator, a low noise amplifier, an antenna array, and the like. It may be understood that the phase shifter and the attenuator shown in FIG. 4b are different from those in FIG. 1 and FIG. 2. The phase shifter, the attenuator, the low noise amplifier, and the like in FIG. 4b may be understood as the radio frequency channels in FIG. 1 and FIG. 2. A phase shifter and an attenuator in the antenna array are not shown in FIG. 4b. The weight generation unit and the angle estimation unit shown in FIG. 4b are merely examples. For example, the weight generation unit may be implemented by a baseband processing circuit. For another example, any antenna element in each of the N subarrays may be used as an angle estimation unit.

It may be understood that the communication apparatus shown in FIG. 4b is merely an example. During specific implementation, there may be another structure. This is not limited in this embodiment of this application. The communication apparatus may be combined with the antenna array shown in FIG. 1 or FIG. 2, or may be combined with Example 1 to Example 7 below.

The antenna array provided in this embodiment of this application not only has high directivity, but also has a high gain. For example, if an element spacing in a subarray is less than a half wavelength, a superdirective subarray can be implemented by properly adjusting amplitudes and phases of elements. When the superdirective subarray is used to form a larger antenna array, directivity of the antenna array is also higher than directivity of a conventional array. Using an antenna height as a dimension breaks through a limitation on directivity of the conventional array imposed by an aperture area. The amplitude and phase control units are used in the subarray, so that the subarray supports beamforming. The subarray can perform beam scanning between endfire and broadside directions, and supports beam scanning from −90 degrees to 90 degrees. Therefore, the antenna array based on the subarray structure can support large-angle scanning, to resolve a problem of a sudden decrease in a gain in a case of large-angle scanning.

The following describes the antenna array provided in this embodiment of this application with reference to specific examples.

### Example 1

The antenna element described in this embodiment of this application may include a monopole antenna. A first end of the monopole antenna is a feed end, a horizontal stub is disposed at a second end of the monopole antenna, and a size of the second end in a direction perpendicular to the monopole antenna is less than or equal to a spacing between antenna elements.

A size of the antenna element in each direction is less than or equal to an antenna element spacing in a corresponding direction, to ensure that an array structure can be formed. Using a monopole structure as the antenna element can effectively ensure structure compactness of the element. A length of the monopole is about a quarter wavelength or less than a quarter wavelength.

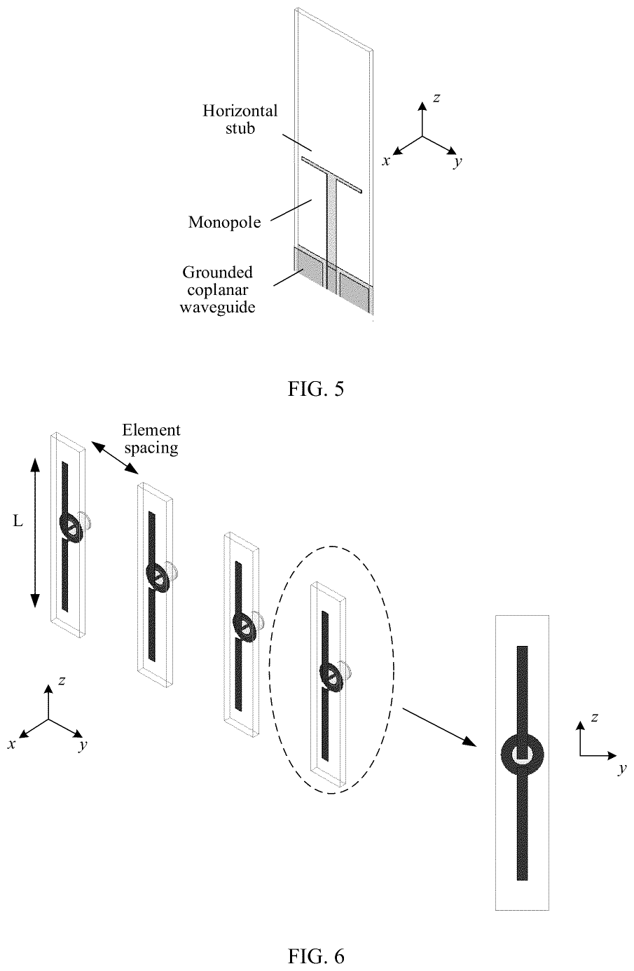

FIG. 5 is a diagram of a structure of a monopole-based antenna element according to an embodiment of this application. As shown in FIG. 5, the second end may be understood as a tail end of the monopole, and the tail end of the monopole is loaded with a horizontal stub, so that a length of the monopole antenna can be effectively reduced. The size of the tail end in the direction perpendicular to the monopole is less than or equal to the spacing between antenna elements. A size of the tail end in a same direction as the monopole is less than or equal to a quarter wavelength. The monopole antenna may be provided with excitation by using a grounded coplanar waveguide or a coplanar waveguide.

In this embodiment of this application, a length of the monopole antenna can be effectively reduced by disposing the horizontal stub at the second end of the monopole antenna, to ensure structure compactness of the antenna element and ensure bandwidth effect.

### Example 2

The antenna element described in this embodiment of this application may include a differentially excited dipole antenna. For example, the differentially excited dipole antenna is used as the antenna element and forms a subarray structure. FIG. 6 is a diagram of a structure of a dipole antenna element based on coaxial differential feeding according to an embodiment of this application. As shown in FIG. 6, each antenna element may be a dipole antenna, and a length L of the antenna element may be a half wavelength. A wavelength is a wavelength of an electromagnetic wave after medium effect is considered. For example, the dipole antenna may be located on a first surface of a dielectric substrate. Each antenna element is fed by a coaxial structure with differential feeding. That is, excitation signals have a same amplitude and opposite phases. A signal line in the middle of the coaxial structure is connected to one side of the dipole via a metal hole on the dielectric substrate, and an outer ground of the coaxial structure is connected to the other side of the dipole via a metal pattern on a second surface of the dielectric substrate. The metal pattern may be a ring structure, or may be a square structure. The metal pattern has a circular hole, and a size of the hole may be equal to (or there is a deviation) a size of a non-metal part enclosed by the coaxial outer ground and the signal line. The first surface and the second surface may be respectively located on an upper surface and a lower surface of the dielectric substrate, or located on two surfaces of different dielectric substrates.

### Example 3

The antenna element described in this embodiment of this application may include a dipole antenna based on a differential microstrip feed structure. For a diagram of a structure of a dipole antenna element based on differential microstrip feeding, refer to FIG. 3b. FIG. 7 is a diagram of a structure of a subarray according to an embodiment of this application. As shown in FIG. 7 and FIG. 3b, each antenna element includes a dipole antenna serving as a radiation part and a transmission part. The transmission part includes a two-wire differential feed structure, a microstrip-two-wire transition structure, a microstrip structure, and the like. For descriptions of the dipole antenna, refer to related descriptions in FIG. 3b. Details are not described herein again. As shown in FIG. 7, an edge of a tapered structure is arranged along y=C₁*e^{a*x}+C₂. By properly adjusting values of C₁, C₂, and a, an impedance matching bandwidth of the antenna can meet a requirement, and a radiation pattern of the dipole is an omnidirectional pattern and has small (for example, less than −15 dB) cross polarization.

The following verifies performance of a superdirective antenna array including a metal ground by using the dipole antenna through full-wave simulation.

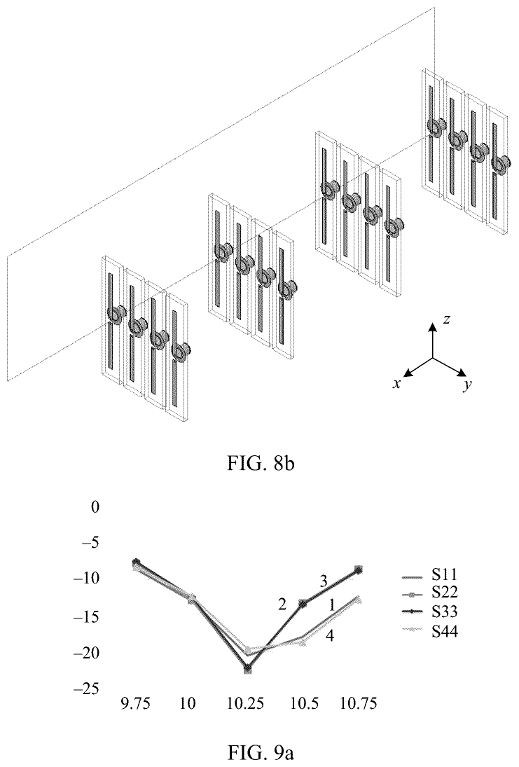

FIG. 8a is a diagram of a structure of a subarray including four antenna elements, and FIG. 8b is a diagram of a structure of a uniform linear array including four subarrays. That is, the structure in FIG. 8a may be used as a subarray, and four subarrays are arranged into a structure shown in FIG. 8b. M1=M2=M3=M4=4, and N=4. The spacing between antenna elements is dy=3 mm=λ/10, where λ is a wavelength of an electromagnetic wave at a frequency band of 10 GHz in a vacuum. Full-wave simulation indicates that directivity of the subarray including four antenna elements shown in FIG. 8a is 10.05 dBi, and a gain is 9.06 dBi. An inter-subarray spacing is dx=15 mm=λ/2. According to full-wave simulation, directivity of the antenna array including four subarrays shown in FIG. 8b is 14.53 dBi, and a gain is 13.76 dBi. It may be understood that parallelograms shown in FIG. 8a and FIG. 8b may be understood as metal grounds.

For example, for a conventional antenna array with a same radiation aperture, when an equivalent aperture is 14 mm*46 mm, according to the foregoing formula

$${D}_{0} = \frac{4 π {A}_{eff}}{{λ}^{2}} ,$$

directivity of the conventional antenna array is D₀=9.54 dBi. It can be learned from the foregoing that, in this embodiment of this application, a compactly coupled endfire array brings an array directivity gain of about 5 dB.

In the structure shown in FIG. 6, when the spacing between antenna elements is dy=7.5 mm=λ/4, a full-wave simulation result indicates that, as shown in FIG. 9a, a bandwidth of each antenna element covers 10 GHz to 10.5 GHz, has a broadband S11 response characteristic, and as shown in FIG. 9b, a directivity change on 10 GHz and 10.5 GHz is small. Each line in FIG. 9a corresponds to a number. For example, the 1^{st} line on the right corresponds to the number 1 in FIG. 9a, the 2^{nd} line corresponds to the number 2 in FIG. 9a, and so on.

As shown in FIG. 10a, an antenna array is in a structure (M₁=M₂=M₃=M₄=M₅=M₆=M7=4, and N=7). An excitation coefficient of an element in each subarray is properly configured, so that the subarray can support beamforming. In a conventional antenna array, when another factor such as polarization is not considered, and each subarray includes one antenna port, beam scanning is implemented by inter-subarray beamforming, and a beam direction is in a broadside direction of the subarray. However, in the antenna array structure provided in this embodiment of this application, each subarray includes a plurality of antenna ports, and a beam direction of the subarray may scan in a broadside direction, an endfire direction, and a plane determined by the broadside direction and the endfire direction. In an example of the structure in FIG. 10a, the endfire direction of the subarray is a +y or −y direction, and the broadside direction is a +x or −x direction. The plane determined by the endfire direction and the broadside direction is an xoy plane. An origin of a coordinate system is o. A beam of the subarray can scan within a range of phi=−90° to 90° after being converted into a spherical coordinate system. The antenna array including the subarrays has enhanced beam scanning effect. For example, when a main lobe angle of the subarray is not phi=−90° or 90°, two main lobes may be generated. However, even in this case, a beam scanning angle is still increased, and a problem that a beam gain is sharply reduced to some extent during large-angle scanning of the array is resolved. FIG. 10b is a diagram of directivity comparison between the subarray (M₁=7 and N=1) and the array (M₁=M₂=M₃=M₄=7, and N=4) including four subarrays (M1=7 and N=1) when a beam of the subarray is in the endfire direction. FIG. 10c is a diagram of directivity comparison between the subarray (M₁=7, N=1) and the array (M₁=M₂=M₃=M₄=7, and N=4) when a beam of the subarray is in the broadside direction. It can be learned that, when the beam of the subarray is in the broadside direction, the subarray and the array each have a main lobe beam in each of a 0° direction and a 180° direction.

It may be understood that, in FIG. 9a, a horizontal coordinate represents a frequency in a unit of GHz, and a vertical coordinate represents an amplitude in a unit of dB. In FIG. 9b, FIG. 10b, and FIG. 10c, a horizontal coordinate represents an angle in a unit of degree, and a vertical coordinate represents directivity in a unit of dBi.

### Example 4

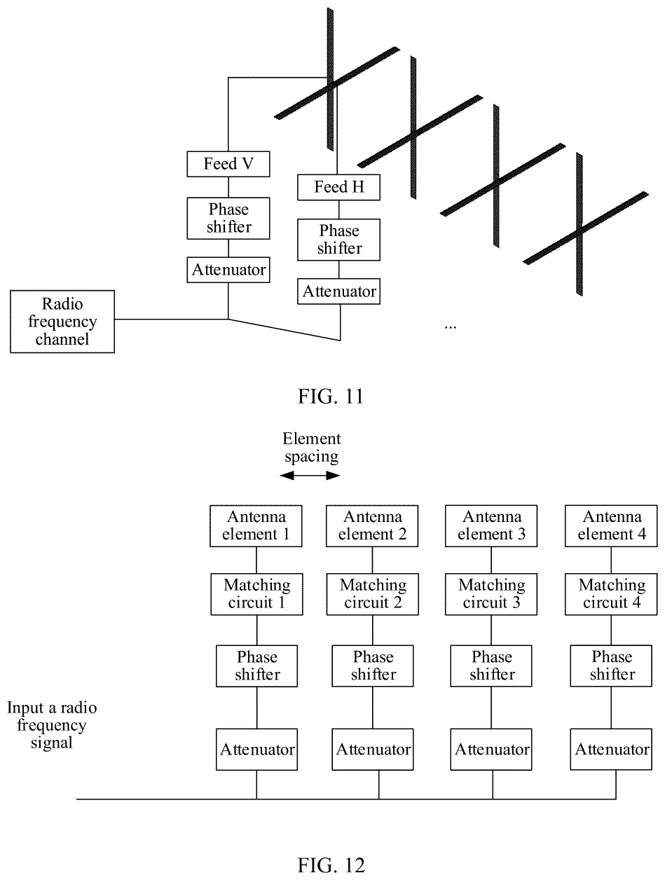

The antenna element described in this embodiment of this application may include a dual-polarized antenna, or two orthogonal polarized antennas. That is, the subarray may be a subarray structure based on a dual-polarized antenna. As shown in FIG. 11, each antenna element in the subarray includes two orthogonal polarizations, and this can effectively improve polarization freedom of and a beamforming dimension. For example, locations of the polarized antennas of the dual-polarized element may not completely overlap, and the polarized antennas may be excited by a feed V and a feed H respectively. An excitation coefficient may be designed in relation to dual polarization and the antenna locations. In addition to the dipole antenna described above, the antenna element may be a planar inverted-F antenna (PIFA), a monopole, or the like. Details are not described in this embodiment of this application. It may be understood that FIG. 11 shows only an example of four dual-polarized antennas, and a quantity of dual-polarized antennas shown in FIG. 11 should not be understood as a limitation on this embodiment of this application.

### Example 5

In this embodiment of this application, at least two of the Mₙ antenna elements correspond to different impedance matching circuits. It may be understood that, that the impedance matching circuits corresponding to the at least two antenna elements are different is described for M, antenna elements in a same subarray. A relationship between an impedance matching circuit in one subarray and an impedance matching circuit in another subarray is not limited in this embodiment of this application.

In an example, each antenna element in one subarray may correspond to a different impedance matching circuit. In another example, two antenna elements in one subarray may correspond to different impedance matching circuits, or three or more antenna elements may correspond to different impedance matching circuits. Generally, a bandwidth of the subarray or the antenna array is determined by an overlapping bandwidth of each antenna element. Due to impact of coupling effect of a surrounding antenna, impedance of an antenna element at an edge of the subarray or the antenna array is inconsistent with impedance of an antenna element in the middle of the subarray or the antenna array. If a same impedance matching circuit is used, the edge antenna element and the middle antenna element cannot match optimal impedance simultaneously, and an overall bandwidth of the subarray or the antenna array is affected. Especially when the antenna spacing is less than or equal to a half wavelength, the surrounding antenna element has greater impact, and the edge and middle antenna elements cannot match impedance simultaneously. Therefore, to improve the overall bandwidth of the subarray or the antenna array, different impedance matching circuits may be used for the edge and middle antenna elements.

FIG. 12 is a diagram of a structure of a subarray based on different impedance matching circuits according to an embodiment of this application. FIG. 12 shows only an example of four antenna elements. A quantity of antenna elements and a quantity of subarrays are not limited in this embodiment of this application. As shown in FIG. 12, an antenna element 1 and an antenna element 4 are located at the edge of the subarray, and therefore have similar impedance. A matching circuit 1 and a matching circuit 4 that respectively correspond to the antenna element 1 and the antenna element 4 may also use similar structures and parameters. An antenna element 2 and an antenna element 3 are located in the middle of the subarray, and therefore also have similar impedance. A matching circuit 2 and a matching circuit 3 that respectively correspond to the antenna element 2 and the antenna element 3 may also use similar structures and parameters. This is similar for a large-scale two-dimensional array and a large-scale three-dimensional array. For example, antenna elements located at an edge of a subarray may use a similar impedance matching circuit, and antenna elements located in a middle of the subarray may use a similar impedance matching circuit.

For example, to implement different impedance matching circuits, a transmission line impedance matching circuit such as a microstrip line may be used at an antenna port, or some parameters of the transmission line may be adjusted, to implement matching for the antenna (for example, a reflection coefficient is less than a coefficient threshold, for example, the coefficient threshold may be equal to −10 dB). FIG. 7 is used as an example. Parameters of a two-wire differential feed structure, a microstrip-two-wire transition structure, and a grounded coplanar waveguide-microstrip transition structure of an antenna element located at an edge and in a middle of the subarray are adjusted, so that each antenna element achieves good matching effect, that is, has a low reflection coefficient and a wide overlapping bandwidth. In addition, the impedance matching circuit may also be formed by a lumped circuit element applied to a corresponding frequency band, for example, implemented by connecting to a proper capacitor or inductor in series or in parallel. A specific implementation of the impedance matching circuit is not limited in this embodiment of this application.

In this embodiment of this application, different impedance matching circuits are used, so that different antenna elements can implement good impedance matching with another radio frequency device such as a phase shifter, to implement good power transmission and improve the overall bandwidth of the antenna.

In this embodiment of this application, each of the Mₙ antenna elements may correspond to one unequal power divider, or a plurality of antenna elements in the Mₙ antenna elements correspond to one unequal power divider. The unequal power divider may be configured to adjust an amplitude of an excitation signal of the antenna element. For example, the amplitude adjustment unit described above may be implemented by the unequal power divider. For description of the unequal power divider, refer to Example 6 and Example 7 below.

### Example 6

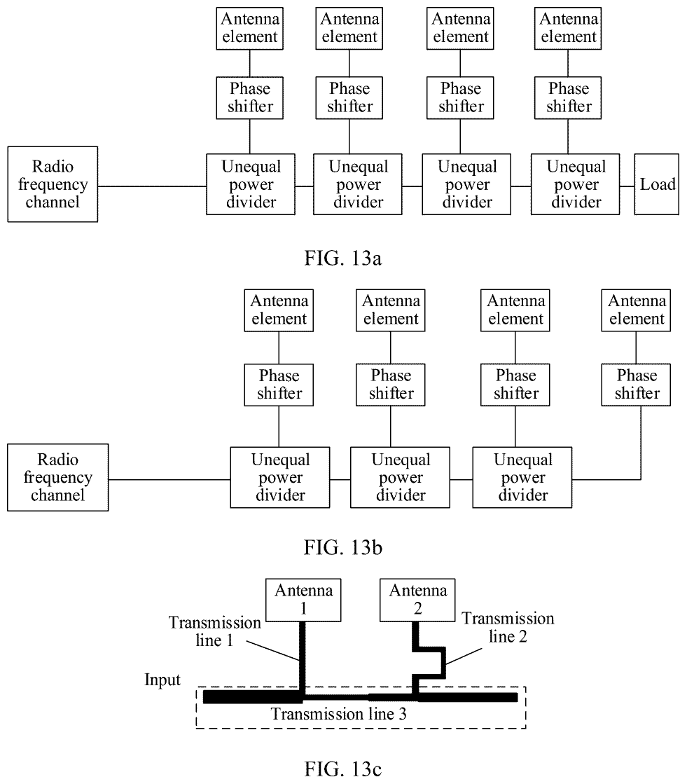

FIG. 13a and FIG. 13b are diagrams of a structure of a subarray based on a series feed network according to an embodiment of this application. As shown in FIG. 13a, the subarray may include an antenna element, an unequal power divider, and a phase shifter. An amplitude of each antenna element may be adjusted by an unequal series feed network, and a phase shift is implemented by the phase shifter. By properly controlling an amplitude and a phase of each antenna element, the superdirective subarray with fixed directivity is realized. It may be understood that the subarray structures shown in FIG. 13a and FIG. 13b are merely examples. A quantity of antenna elements included in one subarray and a quantity of subarrays included in one antenna array are not limited in this embodiment of this application. It may be understood that, in the antenna arrays shown in FIG. 1 and FIG. 2, an example in which an attenuator adjusts an amplitude of an excitation signal of an antenna element is used. However, in FIG. 13a and FIG. 13b, an example in which an unequal power divider adjusts an amplitude of an excitation signal of an antenna element is used. Structures of the antenna arrays shown in FIG. 1 and FIG. 2 should not be understood as a limitation on this embodiment of this application.

For example, the unequal power divider may be constructed by a microstrip, a strip line, or a waveguide. A Wilkinson power divider may also be used. For example, the unequal power divider may also use a leaky-wave structure, and an excitation amplitude of each antenna port may be changed by changing a value of leaked energy. For example, the unequal power divider may use a coupled feed structure, and an excitation amplitude of each antenna port is changed by changing a value of a coupling coefficient. FIG. 13c is a diagram of a fixed amplitude and phase adjustment structure based on a microstrip structure according to an embodiment of this application. As shown in FIG. 13c, power allocated to each antenna port may be changed by properly setting impedance of a transmission line. As shown in FIG. 13c, different widths of a transmission line 3 indicate different impedance of the transmission line. A phase of each antenna port may be constructed by using transmission lines of different lengths or digital phase shifters. For example, an excitation phase of each antenna is changed by using transmission lines of different lengths, to implement a required fixed phase. As shown in FIG. 13c, lengths of a transmission line 1 connected to an antenna 1 and a transmission line 2 connected to an antenna 2 are different. When the phase shifter includes a digital phase shifter, the antenna array may further implement phase adjustability.

It may be understood that the last unequal power divider shown in FIG. 13a and FIG. 13b may be configured to perform equal amplitude division. Therefore, the last unequal power divider in FIG. 13a and FIG. 13b may be an equal power divider. That is, the equal power divider in this embodiment of this application may be used as a special example of the unequal power divider.

In the antenna array described in this embodiment of this application, each antenna element may correspond to one unequal power divider, so that a structure of the antenna array is more compact, and power consumption can be further reduced.

### Example 7

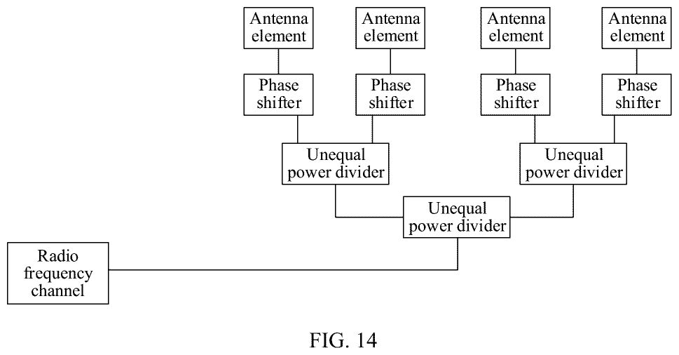

FIG. 14 is a diagram of a structure of a subarray based on a parallel feed network according to an embodiment of this application. As shown in FIG. 14, the subarray may include an antenna element, an unequal power divider, and a phase shifter. An amplitude of each antenna element may be adjusted by an unequal parallel feed network, and a phase shift is implemented by the phase shifter. The phase shifter may be of a fixed phase or an adjustable phase. The parallel feed network may be constructed by a plurality of 1-to-2 power dividers. Each unequal power divider may unequally divide power to two output ports, and so on. For descriptions of the unequal power divider and the phase shifter, refer to Example 6. Details are not described herein again.

In the antenna array described in this embodiment of this application, the subarray structure based on the parallel feed network is used to reduce system complexity and power consumption.

It should be noted that the foregoing examples may be combined with each other. For example, Example 6 or Example 7 may be combined with Example 1 to Example 5 separately. For another example, any one of Example 1 to Example 4 may be combined with Example 5. Example 1 to Example 7 each may be combined with FIG. 1 or FIG. 2, or Example 1 to Example 7 each may be combined with FIG. 4b, or FIG. 1 or FIG. 2 may be combined with FIG. 4b, or the like.

### Examples are not Enumerated Herein

The antenna array provided in this embodiment of this application may implement at least one of the following:
1. A high directivity gain and a high antenna gain are derived from a superdirective endfire antenna array structure. Both the subarray and the antenna array have a higher gain and higher directivity than a conventional array.
2. A gain in a scanning angle is derived from respectively generating a scanning angle weight and a superdirective weight in a broadside or endfire direction of a subarray, and beamforming of the superdirective subarray is supported, to resolve a problem that mutual coupling matrix is related to a scanning angle.
3. A gain in supported broadband communication is derived from an S11 broadband response in a case of mutual coupling enabled by using a broadband differential feed structure such as a coaxial structure, a two-wire structure, or a stub-loaded monopole. Certainly, the monopole described herein is merely an example. For other antenna elements, refer to the foregoing descriptions.

An embodiment of this application further provides an active antenna unit (AAU). The AAU may include the antenna array described above. The AAU may be understood as a main device of a network device, and can effectively implement a large-scale antenna array.

An embodiment of this application further provides a communication apparatus. The communication apparatus may include the antenna array and the baseband processing circuit described above. For example, the communication apparatus may be a terminal device. For another example, the communication apparatus may be a network device. For example, the terminal device is an apparatus having a wireless transceiver function. The terminal device may communicate with an access network device (or referred to as an access device) in a radio access network (RAN). The terminal device may also be referred to as user equipment (UE), an access terminal, a terminal, a subscriber unit, a subscriber station, a mobile station, a remote station, a remote terminal, a mobile device, a user terminal, a user agent, a user apparatus, or the like. In an optional implementation, the terminal device may be deployed on land, including an indoor, outdoor, handheld, or vehicle-mounted device; or may be deployed on the water (for example, a ship), or the like. In an optional implementation, the terminal device may be a handheld device having a wireless communication function, a vehicle-mounted device, a wearable device, a sensor, a terminal in an internet of things, a terminal in an internet of vehicles, an unmanned aerial vehicle, a terminal device in any form in a 5G network or a future network, or the like. This is not limited in embodiments of this application. It may be understood that the terminal device described in embodiments of this application may include a vehicle (for example, a car) in the internet of vehicles, and may further include a vehicle-mounted device, a vehicle-mounted terminal, or the like in the internet of vehicles. A specific form of the terminal device used in the internet of vehicles is not limited in embodiments of this application.

For example, the network device may be an apparatus that is deployed in the radio access network and that provides a wireless communication service for the terminal device. The network device may also be referred to as an access network device, an access device, a RAN device, or the like. For example, the network device may be a next generation NodeB (gNB), a next generation evolved NodeB (ng-eNB), or a network device in 6G communication. The network device may be any device having a wireless transceiver function, and includes but is not limited to the base station described above (including a base station deployed on a satellite). Alternatively, the network device may be an apparatus that has a base station function in 6G. Optionally, the network device may be an access node, a wireless relay node, a wireless backhaul node, or the like in a Wi-Fi system. Optionally, the network device may be a radio controller in a cloud radio access network (CRAN) scenario. Optionally, the network device may be a wearable device, a vehicle-mounted device, or the like. Optionally, the network device may be a small cell, a transmission reception point (TRP) (or may be referred to as a transmission point), or the like. It may be understood that the network device may alternatively be a base station, a satellite, or the like in a future evolved public land mobile network (PLMN). Alternatively, the network device may be a communication apparatus that carries a base station function in a non-terrestrial communication system, D2D, V2X, or M2Mₙ or the like. A specific type of the network device is not limited in embodiments of this application. Optionally, in some deployments of the network device, the network device may include a central unit (CU), a distributed unit (DU), and the like. In some other deployments of the network device, the CU may be further divided into a CU-control plane (CP), a CU-user plane (UP), and the like. In some other deployments of the network device, the network device may alternatively be an antenna unit (RU), or the like. In still some other deployments of the network device, the network device may alternatively be an open radio access network (ORAN) architecture or the like. A specific deployment manner of the network device is not limited in embodiments of this application. For example, when the network device is of the ORAN architecture, the network device in embodiments of this application may be an access network device in an ORAN, a module in the access network device, or the like. In an ORAN system, a CU may also be referred to as an open (O)-CU, a DU may also be referred to as an O-DU, a CU-CP may also be referred to as an O-CU-CP, a CU-UP may also be referred to as an O-CU-UP, and an RU may also be referred to as an O-RU. Deployment manners of the network device described herein are merely examples. With evolution of a standard technology, the network device may have another deployment manner. However, any network device having the antenna array described in embodiments of this application falls within the protection scope of embodiments of this application.

It may be understood that the communication apparatus described in embodiments of this application may be used in a radio frequency wireless system such as a wireless communication system, a wireless positioning system, a sensing system, or an imaging system. Certainly, the foregoing communication apparatus may be further used in another system, which is not enumerated herein.

1. An antenna array, comprising:
N subarrays, wherein the n^{t}h subarray comprises Mₙ antenna elements, N is an integer greater than 1, a value of n is an integer ranging from 1 to N, Mₙ is a positive integer, and a quantity of antenna elements in at least one of the N subarrays is greater than 1;
when Mₙ is greater than 1, the Mₙ antenna elements are arranged in a first direction, a spacing between adjacent antenna elements in the Mₙ antenna elements is less than or equal to ½ λ, and λ is an operating wavelength of the antenna array; and
the N subarrays are arranged in a second direction, and the first direction is perpendicular to the second direction; or N₁ subarrays are arranged in the second direction, and N₂ subarrays are arranged in a third direction, wherein N₁ and N₂ are both positive integers, the first direction is perpendicular to the second direction, the second direction is perpendicular to the third direction, and the first direction is perpendicular to the third direction.

2. The antenna array according to claim 1, wherein the N₁ subarrays are arranged in the second direction, the N₂ subarrays are arranged in the third direction, and N=N₁*N₂.

3. The antenna array according to claim 1, wherein the first direction is a beam direction of the subarray.

4. The antenna array according to claim 1, wherein at least one spacing between adjacent antenna elements in the Mₙ antenna elements is less than or equal to ¼ λ.

5. The antenna array according to claim 1, wherein the antenna element comprises a monopole antenna, a first end of the monopole antenna is a feed end, a horizontal stub is disposed at a second end of the monopole antenna, and a size of the second end in a direction perpendicular to the monopole antenna is less than or equal to the spacing between antenna elements.

6. The antenna array according to claim 1, wherein the antenna element comprises any one of the following: a differentially excited dipole antenna, a dipole antenna with a differential microstrip feed structure, and a dual-polarized antenna.

7. The antenna array according to claim 1, wherein each antenna element is connected to an amplitude adjustment unit and a phase adjustment unit, the amplitude adjustment unit is configured to adjust an amplitude of an excitation signal of the corresponding antenna element based on a weight, and the phase adjustment unit is configured to adjust a phase of an excitation signal of the corresponding antenna element based on a weight.

8. The antenna array according to claim 7, wherein the antenna array further comprises a weight generation unit, and the weight generation unit is configured to generate the weight.

9. The antenna array according to claim 7, wherein the weight comprises a superdirective weight, and the antenna array is configured to use the superdirective weight to generate a superdirective beam.

10. The antenna array according to claim 1, wherein at least two of the Mₙ antenna elements correspond to different impedance matching circuits.

11. The antenna array according to claim 7, wherein the amplitude adjustment unit comprises an unequal power divider, and each of the Mₙ antenna elements corresponds to one unequal power divider, or a plurality of antenna elements in the Mₙ antenna elements correspond to one unequal power divider.

12. The antenna array according to claim 1, wherein beamforming used between subarrays comprises at least one of the following: digital beamforming and analog beamforming.

13. An active antenna unit, comprising an antenna array, wherein the antenna array comprises:
N subarrays, wherein the n^{t}h subarray comprises Mₙ antenna elements, N is an integer greater than 1, a value of n is an integer ranging from 1 to N, Mₙ is a positive integer, and a quantity of antenna elements in at least one of the N subarrays is greater than 1;
when Mₙ is greater than 1, the Mₙ antenna elements are arranged in a first direction, a spacing between adjacent antenna elements in the Mₙ antenna elements is less than or equal to ½ λ, and λ is an operating wavelength of the antenna array; and
the N subarrays are arranged in a second direction, and the first direction is perpendicular to the second direction; or N₁ subarrays are arranged in the second direction, and N₂ subarrays are arranged in a third direction, wherein N₁ and N₂ are both positive integers, the first direction is perpendicular to the second direction, the second direction is perpendicular to the third direction, and the first direction is perpendicular to the third direction.

14. The active antenna unit according to claim 13, wherein the N₁ subarrays are arranged in the second direction, the N₂ subarrays are arranged in the third direction, and N=N₁*N₂.

15. The active antenna unit according to claim 13, wherein the first direction is a beam direction of the subarray.

16. The active antenna unit according to claim 13, wherein at least one spacing between adjacent antenna elements in the Mₙ antenna elements is less than or equal to ¼ λ.

17. A communication apparatus, comprising an antenna array and a baseband processing circuit, wherein the antenna array comprises:
N subarrays, wherein the n^{t}h subarray comprises Mₙ antenna elements, N is an integer greater than 1, a value of n is an integer ranging from 1 to N, Mₙ is a positive integer, and a quantity of antenna elements in at least one of the N subarrays is greater than 1;
when Mₙ is greater than 1, the Mₙ antenna elements are arranged in a first direction, a spacing between adjacent antenna elements in the Mₙ antenna elements is less than or equal to ½ λ, and λ is an operating wavelength of the antenna array; and
the N subarrays are arranged in a second direction, and the first direction is perpendicular to the second direction; or N₁ subarrays are arranged in the second direction, and N₂ subarrays are arranged in a third direction, wherein N₁ and N₂ are both positive integers, the first direction is perpendicular to the second direction, the second direction is perpendicular to the third direction, and the first direction is perpendicular to the third direction.

18. The communication apparatus according to claim 17, the N₁ subarrays are arranged in the second direction, the N₂ subarrays are arranged in the third direction, and wherein N=N₁*N₂.

19. The communication apparatus according to claim 17, wherein the first direction is a beam direction of the subarray.

20. The communication apparatus according to claim 17, wherein at least one spacing between adjacent antenna elements in the Mₙ antenna elements is less than or equal to ¼ λ.
